(19) United States
(12) Patent Application Publication
(10) Pub. No.: US 2009/0025238 A1
(43) Pub. Date: Jan. 29, 2009

(54) CONSTRUCTION TOOL FOR INSTALLING STAIRWAY COMPONENTS

(76) Inventor: James L. Bowman, Prudenville, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/828,438

(22) Filed: Jul. 26, 2007

(51) Int. Cl. B43L 13/00; B43L 7/12

(52) U.S. Cl. 33/472; 33/424

(57) ABSTRACT

A tool (100) for use in the construction of a stairway includes a height adjustment section (117) for measuring the height above a stair tread and a second measurement section (200) pivotably attached to the height adjustment section (117) for measuring an angle (α, β) between the tool body (101) and the straight edge (213) on the second measurement section (200). The tool body (101) includes vertical clamp brace (103) and horizontal clamp brace (110) for attaching the tool body (101) to a stair tread.

### FIELD OF THE INVENTION

The present invention relates generally to a device for installing stairway components and more particularly to tools for installing stairway treads, risers, handrails, newels, and balusters.

### BACKGROUND

Both commercial and residential builders are often involved in construction projects that require the use of precise heights and angles in order to meet strict building codes. One of these types of projects is the installation of a stairway that is often used for providing access to adjoining floors in a basement or multistory structure. Not only must the risers and stair treads be installed to allow the stairs to rise at a predetermined angle, additional stairway components must also be constructed to match the stairway orientation such that the stairway is not only safe but also looks appealing to the user.

Many types of angle measurement devices have been used in the prior art by those in the construction trades for projects involving angular measurements. For example, U.S. Pat. No. 6,954,990 to Ellis teaches an angle measuring device that combines a carpenter level with a measurement scale that are both affixed against a protractor for measuring roof pitches and gradients. U.S. Pat. No. 5,533,270 to van der Heiden teaches a device that connects between stair treads for determining angles during stair construction. Finally, U.S. Pat. No. 4,736.524 to King teaches a framing T-square and protractor that includes an elongated rule for use in roofing installations or carpentry work.

The problem with these types of construction measurement devices used in the prior art is that they do not operate well for stairway construction projects. Many of these prior art devices are used for roof installations and cannot be manipulated to work easily when used for the installation of rails, risers, handrails, newels, balusters, and/or other stairway assemblies. Accordingly, a construction device is required for enabling a carpenter to more easily build a stairway assembly requiring angular and height measurements and for allowing safe construction and a pleasant appearance of the stairway in conformance with various building code requirements.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a perspective view of the construction tool for installing stairway components in accordance with an embodiment of the invention.

FIG. 2. is a top view of the protractor portion of the construction tool shown in FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a construction tool for installing stairway components. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

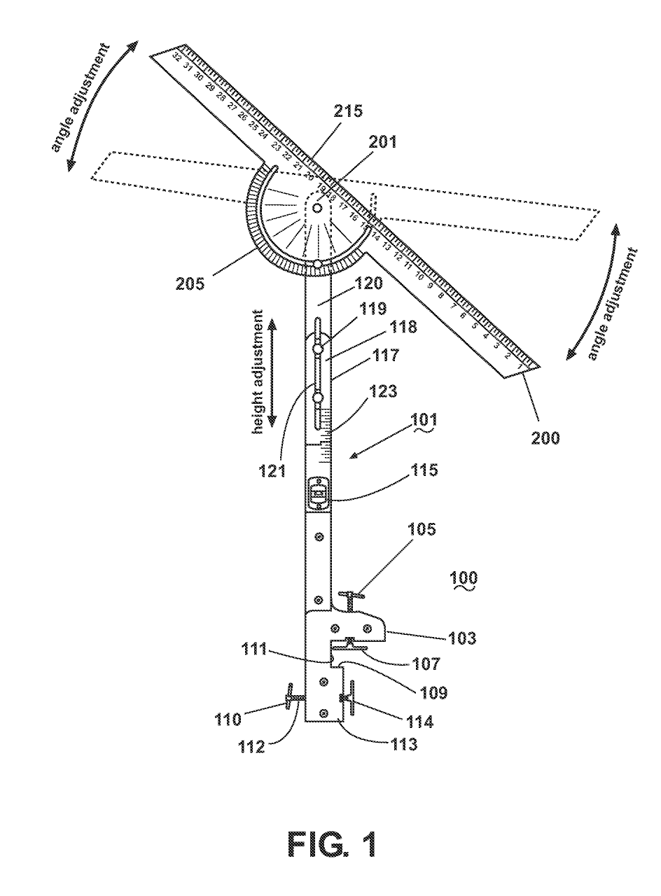

FIG. 1 illustrates a perspective view of the construction tool 100 for use in a stairway assembly. The tool 100 is typically manufactured from a metal or hard extruded plastic material and includes a tool body 101 which is typically oriented orthogonal to a stair tread (not shown). A lower section of the body 101 includes a vertical clamp brace 103 that works with a screw 105 and head 107. In operation, an end of a stair tread is engaged within the head 107 and stop 109 where the screw 105 is used to tighten the head 107 to the face of a tread. This works to securely hold the stair tread in the notch 111 located between the head 107 and step 109 so the tool can be used for measurements in stairway construction. The butt 113 of the tool hangs below the tread to provide additional support. A horizontal clamp brace 110 includes a screw 112 and head 114 that operates to orient the body 101 at a predetermined position in relation to a stair tread and riser (not shown).

A height adjustment section 117 is located above the vertical clamp brace 103 and includes a bubble level 115 positioned between the edges of the body 101. The height adjustment section 117 is positioned on top of the body 101 so that one or more fasteners 119, affixed to the body 101, slide in a notched area 121 so that the overall height of the tool 100 can be adjusted based on a measurement from a rule 123. The rule 123 measures the over all length of the construction tool 100 from the protractor edge of the tool to the tread (not shown). In normal use, the building code typically requires that a stairway handrail be set between 36 to 42 inches above the stair tread. Although inches have been used in this example, the rule 123 may be calibrated in other measures such as used in the metric system or the like. The height adjustment section 117 includes a lower adjustment section 118 and an upper adjustment section 120 that are slidably mounted such that the can be adjusted to a desired height 120 using the rule 123. Thereafter, the fasteners 119 are used to tighten the height measurement section 117 to the body 101 such that the height of the tool 100 is held into a rigid position while in use in order to obtain an accurate measurement. Hence, this portion of the tool may also be used to set the predetermined height of a stairway handrail, newel post. or baluster.

As described in more detail herein, at the upper edge of the upper adjustment section 120 is an adjustable protractor 200 used for measuring lengths using rule 215 and/or setting the correct angle of a stairway handrail using scale 205 The protractor 200 is attached to an upper end 201 of the adjustment section 117 through the use of a bolt, bushing or other adjustable fastener for allowing a pivoting motion about a center point.

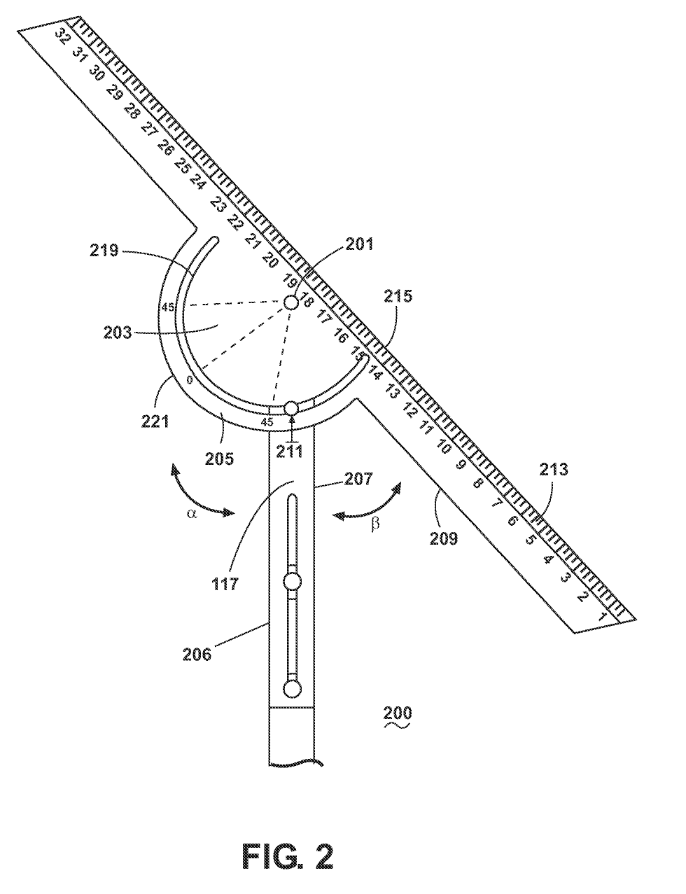

FIG. 2 illustrates a top view of the adjustable protractor 200. The protractor 200 includes a semi-circular top section 203 that includes a scale 205 and scribe line 211 for measuring a predetermined angle. By way of example, the angle α is the angle outside the scribe line 211 of the adjustment section 117 and the inner edge 209 of the protractor 209. Similarly, the angle β is the angle between an inside the scribe line 211 and an inside edge 209 of the protractor 200. The angle β is used with the straight edge section 213 in order to adjust the angle of a stairway rail relative to the stair tread during the construction process. The angles α+β=approximately 180 degrees.

Many building codes require the a stairway handrail be installed at an angle of approximately 30 to 45 degrees in relation to the stair tread allowing the construction tool to aid the carpenter in establishing this angle. Moreover, the straight edge section 213 of the protractor 200 further includes a rule 215 for measuring distances typically between 1 to 3 feet in length. In operation, the rule 200 is pivoted about the adjustable fastener 201 where a rivet 217 or other mechanical device rides within a semicircular channel 219 located just above the scale 205. This allows the protractor 200 to be rotated about the adjustable fastener 201 to either a positive or negative position for measuring angle α or angle β in relation to the zero degree point 221.

Thus, the present invention is directed to construction tool for use in building stairways and their associated components. The construction tool includes a height measurement section for adjusting a lower adjustment section and an upper adjustment section to a predetermined height above a stair tread. An angular measurement section is pivotable about the adjustable height measurement section and is used for determining a predetermined angle for mounting stairway components. A plumb level is positioned within the lower adjustment section and is used for determining if the adjustable height measurement section is in a substantially vertical position. A rule is integrated into the lower adjustment section for measuring the predetermined height of the tool while a notch is formed below the rule for frictionally engaging with a portion of the stair tread. One or more mounting clamps are integrated with the lower adjustment section for holding the portion of the stair tread within the notch. The lower adjustment section and upper measurement section are slidably mounted over one another for setting the predetermined height of the tool above a stair tread.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

I claim:

1. A tool for use in the construction of a stairway comprising:
a first measurement section for measuring the height above a stair tread;
a second measurement section attached to the first measurement section for measuring an angle between the first measurement section and a straight edge on the second measurement section; and
wherein first measurement section includes a clamp for attaching the first measurement section to the stair tread.

2. A tool for use in the construction of a stairway as in claim 1, further comprising:
a level located in the first measurement section for determining if the first measurement section is plumb in a vertical plane.

3. A tool for use in the construction of a stairway as in claim 1, wherein the second measurement section is a semicircular protractor.

4. A tool for use in the construction of a stairway as in claim 1, wherein the first measurement section is comprised of:
an attachment section including the clamp; and
an adjustment section slidably attached to the attachment section for adjusting the overall length of the first measurement section.

5. A tool for use in the construction of a stairway as in claim 1, further comprising:
a notch positioned within the first measurement section for engaging with a portion of the stair tread.

6. A device for use in the construction of a stairway comprising:
a height adjustment section comprised of a plurality of sliding members for determining a height measurement above a stair tread;
an angular measurement section attached to the height adjustment section for determining an angle for mounting stairway components; and
a mounting clamp integrated with the height adjustment section for fastening the height adjustment section to a stair tread.

7. A device for use in the construction of a stairway as in claim 6 further comprising:
a plumb level attached to the height adjustment section for positioning the height adjustment section orthogonally with a stair tread.

8. A device for use in the construction of a stairway as in claim 6 wherein the sliding members include a first sliding member and second sliding member that substantially overlap in order to set a desired height.

9. A device for use in the construction of a stairway as in claim 6 further comprising:
at least one rule positioned adjacent to the plurality of sliding members for determining a desired height measurement.

10. A device for use in the construction of a stairway as in claim 6, wherein the mounting clamp includes a screw for tightening the mounting clamp against the tread.

11. A device for use in the construction of a stairway as in claim 6, further comprising:
a notch located adjacent to the mounting clamp for engaging a portion of a stair tread.

12. A device for use in the construction of a stairway as in claim 11, further comprising:
a screw for positioning a brace against the stair tread for holding the height adjustment section rigidly to the stair tread.

13. A measurement tool for use in the construction of a stairway comprising:
an adjustable height measurement section for adjusting a first adjustment section and second adjustment section to a predetermined height above a stair tread;
an angular measurement section pivotable about the adjustable height measurement section for determining a predetermined angle for mounting stairway components;
a plumb level positioned within the first adjustment section for determining if the adjustable height measurement section is in a substantially vertical position;
a rule positioned adjacent to the first adjustment section for measuring the predetermined height;
a notch formed within the adjustable height measurement section for frictionally engaging with a portion of the stair tread;
a mounting clamp integrated with the adjustable height measurement section for holding the portion of the stair tread within the notch; and
wherein the first adjustment section and second adjustment section are slidably mounted to one another for setting the predetermined height.

14. A measurement tool for use in the construction of a stairway as in claim 13, wherein the angular measurement section is configured like a protractor.

15. A measurement tool for use in the construction of a stairway as in claim 13, wherein the angular measurement section includes a straight edge.

16. A measurement tool for use in the construction of a stairway as in claim 13, further comprising a fastener for holding the angular measurement section into a fixed position.

17. A measurement tool for use in the construction of a stairway as in claim 13, wherein the mounting clamp includes a screw for holding the clamp to the stair tread.
